(19) United States
(12) Patent Application Publication
(10) Pub. No.: US 2025/0310312 A1
(43) Pub. Date: Oct. 2, 2025

(54) METHOD FOR CONFIGURING A USER DEVICE, USER DEVICE ALONG WITH COMPUTER PROGRAM, COMPUTER-READABLE DATA CARRIER AND DEVICE ARRANGEMENT THEREFOR

(71) Applicant: Giesecke+Devrient Mobile Security Germany GmbH, Munich (DE)

(72) Inventors: Claus JARNIK, Munich (DE); Monika ECKARDT, Munich (DE)

(21) Appl. No.: 19/090,957

(22) Filed: Mar. 26, 2025

(30) Foreign Application Priority Data
Mar. 28, 2024 (DE) 10 2024 108 995.4

(51) Int. Cl. H04L 9/40

(52) U.S. Cl. CPC H04L 63/08

(57) ABSTRACT

Disclosed is a method, a computer program, a computer-readable data carrier, a user device having a device assembly on which a secure element, in particular an eUICC, is installed, and a device arrangement for user devices, for example mobile user devices, for participation in a telecommunication network. The method includes the following steps: predefining a command data set with operating commands for the user device; checking a binding between the device assembly and the secure element; and denying at least one of the operating commands if the check has indicated that no authorized binding is present.

### FIELD OF THE INVENTION

The invention relates to a binding of embedded secure elements with device assemblies of user devices. The embedded secure element can, in particular, be an embedded universal integrated circuit card (eUICC). In particular, the invention relates to a method for configuring a user device, for example a mobile user device for participation in a telecommunication network, having a device assembly on which a secure element, in particular an eUICC, is installed, a computer program, a computer-readable data carrier, a user device, in particular a mobile user device for participation in a communication network, and a device arrangement for configuring user devices.

### BACKGROUND TO THE INVENTION

Methods for handling embedded secure elements, such as eUICCs, as well as computer programs, computer-readable data carriers, user devices for participation in communication networks and communication networks are known from the prior art. Identification characteristics of users of the user devices are thus managed on eUICCs, for example on mobile user devices such as cell phones, smartphones, tablets, or similar devices. On an eUICC, this is usually done in the form of corresponding embedded subscriber identity modules (eSIMs). This procedure is necessary in order to meet security requirements necessary for managing the identification features. This requires a trusted party that can be provided on eUICCs and/or servers, such as eSIM download servers, from which eUICC data sets can be obtained or managed as trusted subscription manager data preparation platforms (SM-DP+) in compliance with respective security requirements.

Secure elements typically have a system structure with an operating system so that they can interact with device assemblies of terminals on which they are implemented. The operating system can be used to access memory areas, usually non-volatile memories, of secure elements and to handle, manage and query information stored therein, such as identification features. For example, this is done using data elements of corresponding application protocol data units (APDUs), which unidirectionally transmit commands via a connection interface to secure elements which then execute these commands.

EP 4113342 A1 relates to a method, a data structure, and an update agent for implementing a scheme for downloading an operating system image onto a secure element. The update agent receives an installation package from an external device to install an operating system on the secure element. The update agent requests control of the secure element and loads the operating system received with the installation package into the secure element, after which control of the secure element is transferred to the operating system.

EP 2862340 B1 relates to a mobile station comprising a terminal and a security element which can be operated, removed or securely implemented in the terminal, wherein a binding is configured between the terminal and the security element and is verifiable by means of a secret key and the verification key. The terminal comprises a secured runtime environment and the verification key is stored in the secured runtime environment.

US20200382957 A1 discloses a method for establishing a secure connection between a secure element of a user device and a node in a network by means of exchange and verification of tokens.

Originally, identity modules for mobile user devices were mechanically interchangeable as subscriber identity cards (SIM cards) or transferable from one user device to another user device, insofar as the respective form factor of the SIM card allowed it. Since the SIM cards are embedded as eSIMs on eUICCs, they can no longer be assigned to a user and/or a telecommunication service provider based on their external characteristics and can no longer be inserted accordingly into a specific intended user device so that they can deploy their full range of functions. The above-mentioned methods, computer programs, computer-readable data carriers, user devices and communication networks do not permit a satisfactory assignment between the secure element and the terminal.

### DESCRIPTION

The object of the present invention is to improve an interaction between secure elements and user devices. In particular, the object of the present invention is to ensure a secure and functionally reliable interaction between secure elements and user devices. The object of the present invention is further to enable a special assignment of secure elements to specific provided user devices.

This object is achieved by the subject-matter of the independent claims. Exemplary embodiments are set out in the dependent claims and in the following description. Features described herein in relation to methods and corresponding method steps can be implemented as device features or vice versa. Sections of the description relating to the method also apply analogously to computer programs, computer-readable data carriers, user devices for participation in communication networks and communication networks. In particular, method steps and components mentioned in relation thereto can be implemented as functions of computer programs, computer-readable data carriers, user devices for participation in communication networks and communication networks, and any functions of computer programs, computer-readable data carriers, user devices for participation in communication networks and communication networks can be implemented as method steps.

A method is described for configuring a user device, for example a mobile user device for participation in a telecommunication network, having a device assembly on which a secure element, in particular an eUICC, is installed, comprising the following steps:
predefining a command data set with operating commands for the user device;
checking a binding between the device assembly and the secure element; and
denying at least one of the operating commands if the check has indicated that no authorized binding is present.

A user device, in particular a mobile terminal for participation in a communication network, comprises a corresponding computer program stored thereon, a corresponding computer-readable data carrier and/or is configured to carry out a corresponding method.

A computer program comprises commands which, when the program is executed by a user device, cause said user device to carry out a corresponding method.

A computer-readable data medium comprises a corresponding computer program stored thereon.

A device arrangement for configuring user devices comprises a corresponding computer program stored therein, a corresponding computer-readable data carrier and/or is configured to carry out a corresponding method.

A device assembly and/or a secure element can comprise a corresponding computer program and/or a corresponding computer-readable data carrier stored thereon and/or can be configured to carry out a corresponding method. The device arrangement can comprise at least one computing device, such as a computer, server, or the like, which is configured to interact with user devices, device assemblies and/or secure elements. The interaction can take place, for example, via a telecommunication network. A telecommunication network comprises at least one corresponding user device and/or a server having a corresponding computer program stored thereon, and a corresponding computer-readable data carrier, or the server is configured to carry out a corresponding method.

The method can be carried out accordingly by a data processing device or by means of a computer, which can be implemented as a user device or server. A computer program can comprise commands which, when the program is executed by a data processing device or a computer, cause said data processing device or said computer to carry out the method. A computer-readable storage medium, a computer-readable data carrier and/or a data carrier signal can store or transmit the computer program. A corresponding computer-readable data carrier can be provided as a computer-readable medium and/or data carrier signal.

At least one of the operating commands of the command data set can be designed as interchangeable between the device assembly and the secure element. The binding can either not be present or cannot meet predefined requirements for the binding. The device assembly can be bound to the secure element using a security key. The binding and/or an authorization of the binding can be initiated from both the device assembly and the secure element.

The solution according to the invention offers the advantage that a potentially insecure and/or functionally indeterminate communication between the device assembly and therefore the user device on the one hand and the secure element on the other hand can be avoided by denying the at least one of the operating commands in the absence of an authorized binding between the device assembly and the secure element. This denied command can relate, for example, to a user-specific and/or provider-specific function that requires a proper authorized binding between the device assembly and the secure element. This helps to improve the interaction between secure elements and user devices, in particular to design it as secure and functionally reliable, while assigning secure elements to predetermined user devices.

The solution is not restricted to eUICCs, but is generally suitable for secure elements (SEs), which are referred to herein, for example, as an integrated circuit card. In addition to eUICCs, secure elements as such comprise, for example, conventional UICCs, integrated UICCs (iUICCs) and all integrated secure elements of other types, such as integrated secure elements (iSE/eSE), smart cards, subscriber identity modules (SIMs) and/or virtual SIMs (vSIMs). A common feature of all such secure elements is that user data sets or eUICC data sets can be stored thereon, for example as telecommunication profiles, or “profiles” for short, by means of which users can authenticate themselves to communication networks, for example as subscribers in telecommunication networks. The secure elements are characterized in that information stored on them, i.e. in particular profiles, is particularly protected against attacks by third parties and is not easily manipulable through either software or hardware.

According to one embodiment, it can be provided that a restricted operating mode is defined in which at least one of the operating commands in the command data set is set as non-executable and/or executable. The restricted operating mode can be activated if no authorized binding is present. At least certain, for example rudimentary, functions, can therefore be performed in the restricted operating mode. A function of the user device can be predefined in the restricted operating mode according to respective requirements. This helps to further improve a secure and functionally reliable interaction between device assemblies and secure elements.

According to one embodiment, it can be provided that the command data set contains at least one command parameter with which the denial and/or a release of at least one of the operating commands is predefinable. The restricted operating mode, for example, or the commands that are non-executable and/or executable therein can be defined and adapted to suit specific requirements by means of the operating parameter. This helps to further improve a secure and functionally reliable interaction between device assemblies and secure elements.

According to one embodiment, it can be provided that the binding is to be authorized depending on an authorization condition. For example, the binding can be technically creatable on the one hand and, on the other hand, can be configured as authorizable linked to an authorization condition. This enables the checking of the binding beyond its technical existence to be linked to a check on the authorization. The authorization, in turn, can be performed according to specific requirements, for example, in connection with a checking of security keys, (authenticity) certificates or similar. This additionally helps to further improve a secure and functionally reliable interaction between device assemblies and secure elements.

According to one embodiment, it can be provided that the binding requires authorization following a predetermined number of uses of at least one operating command and/or at least one operating action of the user device, the device assembly and/or the secure element. The binding may require authorization following a reset of the user device, the device assembly and/or the secure element to a predefined state. For example, the authorization may be required after each reset, after n configured commands/operations (any commands or special commands/operations) and/or before configured commands (e.g. specific applications can thus be rejected with a specific error code that indicates a re-authentication) and/or after a certain time has elapsed. Such operating commands, operating actions and/or operating conditions can be used as and/or associated with authorization conditions. This helps to flexibly adapt and control a secure and functionally reliable interaction between device assemblies and secure elements according to respective requirements.

According to one embodiment, it can be provided that at least one of the steps of predefining, checking and denying is designed as activatable and/or deactivatable. In other words, corresponding method steps can be implemented, but do not have to be activated. This further helps to flexibly adapt and control a secure and functionally reliable interaction between device assemblies and secure elements according to respective requirements.

### BRIEF DESCRIPTION OF THE FIGURES

FIG. 1 shows a schematic view of an exemplary embodiment of a device arrangement according to the invention having a user device and a server which are designed to carry out a method for configuring the user device.

FIG. 2 shows a schematic view of a further exemplary embodiment of a device arrangement according to the invention having a user device and a server which are designed to carry out a method for configuring the user device.

FIG. 3 shows a schematic view of a sequence diagram of steps for checking a binding between a device assembly and a secure element of a user device using a method according to the invention for configuring the user device.

FIG. 4 shows a schematic view of a sequence diagram of steps for creating a binding between a device assembly and a secure element of a user device using a method according to the invention for configuring the user device.

FIG. 5 shows a schematic view of a sequence diagram of steps for checking an authorization of a binding between a device assembly and a secure element of a user device using a method according to the invention for configuring the user device.

### DETAILED DESCRIPTION OF EXEMPLARY EMBODIMENTS

The illustrations in the figures are schematic and are not true-to-scale. If the same reference signs are used in different figures in the following description of the figures, these reference signs designate the same or similar elements. However, the same or similar elements can also be designated by different reference signs.

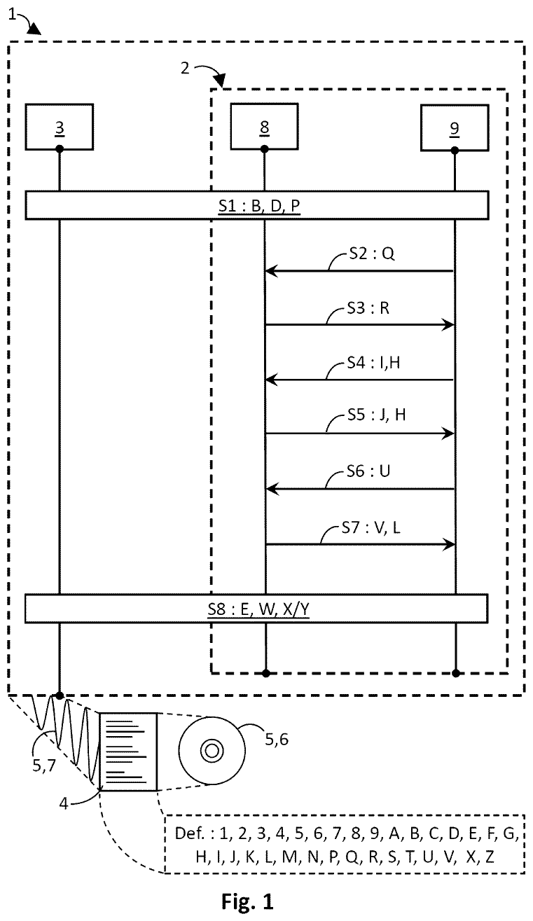

FIG. 1 shows a schematic view of a device system 1 according to the invention having a user device 2 and a computing device in the form of a server 3. The user device 2 and the server 3 can carry out a method according to the invention using a computer program 4 on the basis of computer-readable instructions contained therein. The computer program 4 can be stored at least in sections on a computer-readable data carrier 5 and can define components of the device system 1 described herein as well as associated parameters, identifiers, values, keys and/or steps S, and can control their creation, use and/or handling. The computer-readable data carrier 5 can be present as a computer-readable medium 6 and/or a data carrier signal 7. In particular, the data carrier signal 7 can be designed as transmittable between user devices 2 and/or the server 3 for the respective execution thereon. The computer program 4 and therefore a corresponding method for configuring the user device 2 can thus be executed on the user device and/or the server 3.

The user device 2 comprises a device assembly 8 and a secure element 9, for example in the form of an integrated circuit card or eUICC, which can execute, at least in sections, the computer program 4 and therefore corresponding method steps S. The device assembly can be designed as or can comprise a communication module and/or motherboard of the user device 2. Communication between the device assembly 8 and the secure element 9 is based on operating commands B, for example in the form of data elements of corresponding application protocol data units (APDUs), which transmit commands unidirectionally via a connection interface to secure elements which then execute these commands. The operating commands B further serve to control functions C of the user device 2.

The operating commands B can be managed in the command data set D. The device arrangement 1, the user device 2, the server and/or the command data set D can further contain parameters P, such as error codes F, limit values G, identifiers K, runtime variables T and/or counting variables Z, which can be linked to the operating commands B and/or functions C or actions M or possible restrictions N, which in turn can be based on and/or connected with the operating commands B. Such parameters P can be managed in the command data set D together with and/or separately from the operating commands B, and also in a method according to the invention and its steps S.

In a first step S1, the command data set D with the operating commands B and possibly any parameters P is predefined for the user device 2. For this purpose, corresponding data can be provided by the server 3 of the device assembly 8 and/or the secure element 9, or can be implemented and/or queried thereon. In a second step S2, a binding W between the device assembly 8 and the secure element 9 can be initiated, for example following a first commissioning of the device assembly 8 and/or the secure element 9 or following activation of a corresponding function C. In the present example, the secure element 9 initiates the binding W by sending a binding request Q to the device assembly 8. In a third step S3, the binding request Q can be confirmed with a request confirmation R. In this example, the device assembly 8 sends the request confirmation R to the secure element 9.

In a fourth step S4, a corresponding key exchange can be initiated by means of the initiation request I to encrypt the binding W using a security key H. In this example, the secure element 9 sends the indexing request I to the device assembly 8. The key exchange can be confirmed in a fifth step S5 by means of the encryption confirmation J, which, in the present example, is sent from the device assembly 8 to the secure element 9.

In a sixth step S6, an authentication request U can be sent to authenticate the binding W. In this example, the secure element 9 sends the authentication request U to the device assembly 8. The authentication can be confirmed in a seventh step S7. In this example, the device assembly 8 sends an authentication confirmation V to the secure element 9, for example using a corresponding certificate L.

The binding procedure is completed in an eighth step S8. If the binding is not configured entirely correctly, at least one of the operating commands B can be deactivated in a restricted operating mode X. If the binding W has been successfully configured, it is possible to switch to an unrestricted operating mode Y in which all or a desired range of operating commands B from the operating data set D are/is executable. If the execution of a command B is essentially permitted, a counting variable Z can be checked to determine whether it lies above or below a certain limit value G for the number of permitted executions. For example, the counting variable Z or the corresponding counter can be reduced by a counting value for each execution and the execution can be denied if the counting variable Z has a value of 0 as the limit value G. If this were the case, a new counting variable Z would have to be reset by means of an authorization. A reliable time source can also be used to check whether a runtime variable T exceeds a corresponding limit value G. If this were the case, a new runtime variable T or runtime extension would have to be provided by means of an authorization.

In addition, for confirmation purposes, a device confirmation E can be created, for example in a secured form by the secure element 9. The configuration confirmation E can be used to indicate to the user device 2 and/or the server 3 that the configuration or creation of the binding W was successful. The user device 2 and/or the server 3 can then initiate corresponding steps to complete the configuration procedure, for example by activating and/or deactivating any remaining operating commands B in the unrestricted operating mode Y, adapting counting variables Z, storing or logging configuration notes, for example by creating a blockchain, etc.

In other words, in this example, the binding W can be initiated in the field after a first boot/startup of user device 2. The secure element 9 can recognize that it has been configured for a binding W and this binding then starts in step S2, for which purpose the secure element can send a corresponding proactive command in the form of the binding request Q to the device assembly 8 in order to notify it of the binding W that is to be implemented. The device assembly 8 can indicate that the binding can be implemented with an “OK” in the form of the request confirmation R. The secure element then sends another proactive command in the form of the initiation request I to start a key exchange according to the prior art, e.g. according to Diffie-Hellman. With the response from the device assembly 8, a common security key H is shared by both components. In the next step, this common security key H is used to check a successful binding W. This can be done by means of a cryptography function according to the prior art, e.g. by means of an AES-CMAC. Following a successful authentication, the secure element 9 can be in the unrestricted mode Y, for example an operational mode, i.e. all functions C and actions M are available as normal.

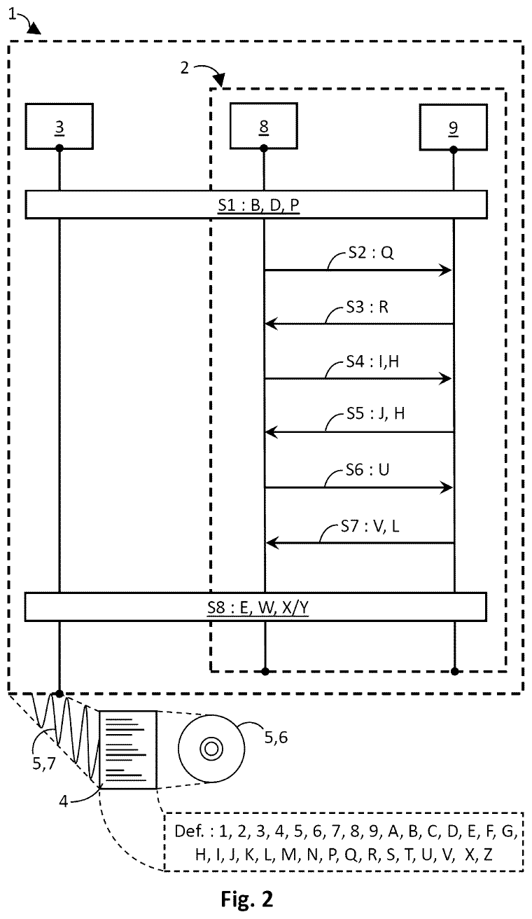

FIG. 2 shows a schematic view of a further exemplary embodiment of a device arrangement 1 according to the invention having the user device 2 and the server 3, which are designed to carry out a method for configuring the user device 2. For the sake of brevity and efficiency, only the differences compared with the exemplary embodiment of the device arrangement 1 shown in FIG. 1 will be described below. Thus, in the exemplary embodiment shown in FIG. 2, the device assembly 8 sends the binding request Q in the second step S2. In the third step S3, the secure element 9 responds with the request confirmation R. In the fourth step S4, the device assembly 8 initiates the exchange of the security key H. In the fifth step S5, the secure element 9 sends the encryption confirmation J. In the sixth step S6, the device assembly 8 sends the authentication request U. In the seventh step S7, the secure element 9 sends the authentication confirmation V, for example using the certificate L, after which the binding procedure can be completed in the eighth step S8.

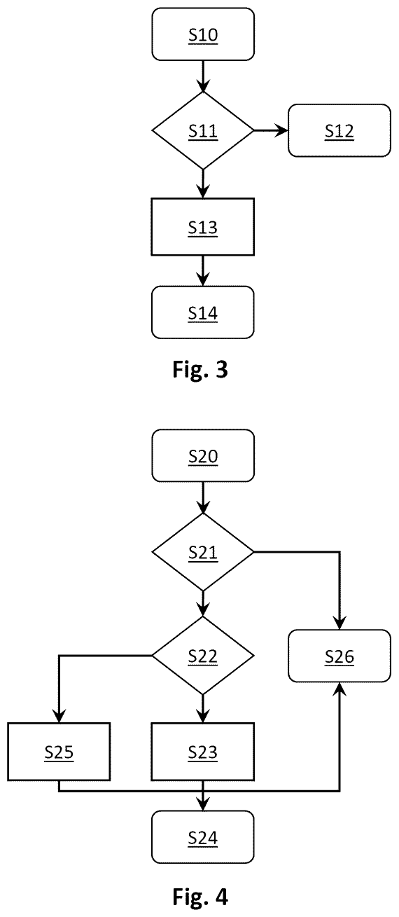

FIG. 3 shows a schematic view of a sequence diagram of steps S for checking a binding W between the device assembly 8 and the secure element 9 of the user device 2 in a method according to the invention for configuring the user device 2. In a tenth step S10, a query can be started if an operating command B, for example an APDU, is to be executed. In an eleventh step S11, a query can be instigated to determine whether a restriction N applies to the execution of the operating command B. If the restriction N applies, a binding W can be implemented and/or queried in a twelfth step S12, for example by switching to step S2, as shown in FIGS. 1 and 2. If the binding W is duly present or is not required, the operation for step S4 can be carried out in step S13. The query can be ended in step S14. In other words, it is possible to check with each new operating command B or with certain operating commands B or commands whether a binding W is configured and necessary. If not, this command continues to be used. If a binding is configured and necessary, a pairing processing is carried out.

FIG. 4 shows a schematic view of a sequence diagram of steps S for creating the binding W between the device assembly 8 and the secure element 9 of the user device 9 using a method according to the invention for configuring the user device 2. Thus, in a twentieth step S20, a check can be started to determine whether a particular operating command B is a command for executing the binding W, for example according to the corresponding restriction N. In a twenty-first step S21, it can be queried whether the operating command B is a command relating to the implementation of the binding W, for example, the initiation request I, the encryption confirmation J, the binding request Q, the request confirmation R, the authentication request U, and/or the authentication confirmation V.

If not, a check can be carried out in a twenty-second step S22, similar to the eleventh step S11, to determine whether the operating command B is allowed or is subject to a restriction N. If no restriction N applies, the operating command B can be executed in a twenty-third step S23, similar to the thirteenth step S13. The check can then be ended in a twenty-fourth step S24. If a restriction N applies, an error with a corresponding error code F can be handled in a twenty-fifth step S25. It is then possible, for example, in a twenty-sixth step S26, to proceed with the implementation of the binding W, as in the twelfth step S12. Alternatively, if the operating command B is a command relating to the implementation of the binding W, it is possible to proceed from the twenty-first step S21 directly to the implementation of the binding W, as shown in FIGS. 1 and 2.

In other words, a check can first be carried out to determine whether the current command is a binding command corresponding to the operating command B. If not, a check is carried on the basis of the current configuration to determine whether the command is permitted or prohibited. If it is permitted, it is further processed. Otherwise, it is rejected according to the configuration. If it is a binding command, the binding operation is processed or performed as shown in FIGS. 1 and 2.

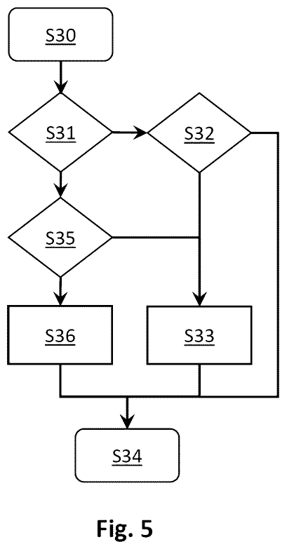

FIG. 5 shows a schematic view of a sequence diagram of steps S for checking an authorization of the binding W between the device assembly 8 and the secure element 9 of the user device 2 using a method according to the invention for configuring the user device 2. In a thirtieth step S30, the check can be instigated, for example, by a certain authorization condition A, action M and/or a corresponding operating command B, such as a reset of the user device 2, the device assembly 8 and/or the secure element 9 to a predetermined operating state. In a thirty-first step S31, a check can be carried out to determine whether the authorization condition A, the action M and/or a corresponding operating command B is/are present.

If the authorization condition A, the action M and/or a corresponding operating command B is present, the authorization of the binding W can be checked in a thirty-second step S32, for example by means of a corresponding authorization request U, authentication confirmation V and/or certificate L. In the event of an authorization error, an error handling can be carried out in a thirty-third step S33 by means of a corresponding error code F, similar to step S25, for example by switching to the restricted operating mode X. If the authentication is successful, the check can be ended in a thirty-fourth step S34, for example by switching to the unrestricted mode Y.

If no authorization condition A, action M and/or corresponding operating command B is present, a check can then be carried out in a thirty-fifth step S35 to determine whether the operating command B or a corresponding APDU requires an authorization of the binding W or is permitted, similar to the twenty-second step S22. If the operating command B is permitted, it can be executed in a thirty-sixth step S36. If the operating command B is not permitted, then error handling can be instigated once more in the thirty-third step S33. If the operating command B is permitted, it can be executed in a thirty-sixth step S36. The check can then be ended once more in the thirty-fourth step S34.

In other words, the authentication of the binding W can be checked once more, for example following a reset to a predetermined operating state, depending on the prompt or trigger. A check can then first be carried out to determine whether the current operating command B or the corresponding command is an authentication command. If so, the authentication is checked, e.g. by means of an AES-CMAC. If the check is successful, the command is accepted and the secure element 9 switches to the unrestricted operating mode Y. Otherwise, any error codes F are displayed accordingly. In the restricted operating mode X, the secure element can then only allow operating commands B that are configured accordingly. If no authentication command is present and if no successful authentication has yet been carried out, only operating commands B corresponding to the configuration of the restricted operating mode X are permitted.

The binding W itself can be specified and initiated in a factory in the context of a secure personalization of the user device 2, the device module 8 and/or the safe element 9, as shown in FIGS. 1 and 2. Once a binding W has been implemented, authentication can be carried out at given times. Depending on the configuration, this authentication can be unilateral or multilateral. In the case of unilateral authentication, for example, only the user device 2 or the device assembly 8 needs to authenticate itself to the secure element 9. In the case of authentications to be performed multilaterally, the device assembly 8 and the secure element 9 must in each case reciprocally authenticate each other.

Possible times for authorizations can be predefined in the user device 2, the device assembly 8 and/or in the secure element 9. Possible times can be, for example: after each reset, after n configured commands/operations (any commands or special commands/operations) according to a respective counting variable Z, before configured operating commands B or commands (e.g. special applications can thus be rejected with a special error code F, indicating a re-authentication on expiration of the corresponding runtime variable T, for example within certain times (the user device 2 sends an authentication request every x minutes/hours or the secure element 9 requests an authentication of the user device 2 every x events/commands (counts)). An exemplary embodiment of a possible command data set D is set out in the following table:

| Authentication | | |
|---|---|---|
| trigger/operating | | |
| command B. | Type | Number |
| Reset | Cold/warm reset | Z |
| APDU | APDU data | Z |
| Function C | Depending on definition | Z |
| Runtime variable T | | |

The restricted operating mode X can be implemented by means of a corresponding format of command data set D. A type of approved or prohibited list can thus be managed for certain operating commands B, synonymous with corresponding commands and/or functions C. For example, the types of APDUs (including information such as CLA, INS, PI, and P2 data bytes, command data) or functions which are allowed can be determined. For each entry, it can be noted whether the corresponding operating command B is permitted or not. It can also be noted, by means of corresponding restrictions N and/or identifiers K, whether a distinction between permitted and prohibited operating commands B can be activated by means of the corresponding configuration setting. For example, such a configuration setting can be deactivated in the factory settings of the user device 2, the device assembly 8 and/or the secure element 9 and can be activated later, as shown abstractly in the following tabular representations of example command data sets D, wherein wildcards or regular expressions such as ‘?’ etc. can be allowed and supported:

| Operating command B | Details | Identifier K |
|---|---|---|
| APDU | Command description | Allowed/not allowed |
| Function C | Description of function | Allowed/not allowed |

| Operating | | | |
|---|---|---|---|
| command | | Restriction N/ | |
| B | Details | identifier K. | Comment |
| APDU | INS = 20 | Allowed | All APDUs with |
| | | | INS = 20: allowed |
| APDU | INS = 30 & | Allowed | All APDUs with |
| | P1 = 30 & | | INS = 30 and |
| | | | P1 = 30 and |
| | P2 = 40 | | P2 = 40: allowed |
| APDU | CLA = 8 & | Forbidden | All APDUs with |
| | INS = 40 | | CLA starting |
| | | | with ‘8’ and |
| | | | INS = 40 allowed |
| APDU | NS = A4 & | Allowed | All APDUs with |
| | Data = “AO00 *” | | CL = A4 and data |
| | | | starting with |
| | | | “A000 *” allowed |
| Function | SGP | Allowed | A functionality called |
| C | ESIOc.GetProfilesInfo | | “SGP |
| | | | ESIOc.GetProfilesInfo” |
| Function | SGP | Forbidden | A functionality called |
| C | ESIOc.EnableProfile | | “SGP |
| | | | ESIOc.EnableProfile” |
| Function | “function A*” | Allowed | All functionalities |
| C | | | starting with |
| | | | “function A” |
| | | | are allowed |
| Function | SE Binding | Activated/ | SE Binding is |
| C | | deactivated | deactivated/not |
| | | | required |
| | | | SE Binding is |
| | | | activated/required |

In this way, command data sets D can be personalized as part of a secure personalization in a manufacturing configuration of the user devices 2, device assemblies 8 and/or secure elements 9 with individual and global data. Alternatively or additionally, the command data sets D can be expanded using lists, for example as part of a corresponding personalization. Commands or changes can be added or made to the command data sets D in ongoing operation or later in the field. In general, a change may require the presence of security keys H in the secure element 9 for a secure data exchange. This can be done, for example, via an OTA connection to a server 3 configured as an OTA server or via the user device 2, for example by means of GlobalPlatform commands.

It is possible to disconnect any bindings W and/or re-initiate them once more. This is possible, for example, in the event of a factory reset when the user device 2 or the device assembly 8 is sold. First, the user device 2 and/or the device assembly 8 must successfully authenticate themselves, e.g. via SGP or GlobalPlatform mechanisms, mutual authentication, etc., and must submit a corresponding request. The secure element 9 can then remove the current binding W and generate a new security key H. This security key H can be exchanged with the user device 2 or the device assembly 8 via a secure transport route (e.g. GlobalPlatform/Diffie-Hellmann). For example, following a successful exchange and verification of the data, this new binding W can then be used. This one rebinding of this type must be atomic.

1. A method for configuring a user device for participating in a telecommunication network, with a device assembly on which a secure element is installed, comprising the following steps:
predefining a command data set with operating commands for the user device;
checking a binding between the device assembly and the secure element; and
denying at least one of the operating commands if the check has shown that no authorized binding is present.

2. The method as claimed in claim 1, wherein a restricted operating mode is defined in which at least one of the operating commands in the command data set is set as non-executable and/or executable.

3. The method as claimed in claim 1, wherein the command data set contains at least one command parameter with which the denial and/or a release of at least one of the operating commands is predefinable.

4. The method as claimed in claim 1, wherein the binding is to be authorized depending on an authorization condition.

5. The method as claimed in claim 1, wherein the binding is to be authorized after a predetermined number of uses of at least one operating command and/or at least one operating action of the user device, the device assembly and/or the secure element.

6. The method as claimed in claim 1, wherein at least one of the steps of predefining, checking and denying is designed as activatable and/or deactivatable.

7. A computer program, wherein commands which, when the program is executed by a user device, cause the user device to carry out the method according to claim 1.

8. A computer-readable data carrier according to claim 7, comprising said computer program stored thereon.

9. A user device according to claim 8, comprising said computer program stored thereon, said computer-readable data carrier, and/or in that the user device is configured to carry out said method.

10. A device arrangement for configuring user devices according to claim 8, comprising said computer program stored therein, said computer-readable data carrier, and/or in that the device arrangement is configured to carry out said method.
